(19) United States
(12) Patent Application Publication
(10) Pub. No.: US 2023/0117736 A1
(43) Pub. Date: Apr. 20, 2023

(54) ELECTROMAGNETIC VIBRATOR FOR GENERATING A VIBRATION IN ORDER TO TRANSMIT SOUND THROUGH A BONE OF A SKULL OF A USER TO AN EAR OF THE USER AND A BONE ANCHORED HEARING DEVICE

(71) Applicant: Oticon Medical A/S, Smørum (DK)

(72) Inventor: Jan PETERSEN, Smørum (DK)

(73) Assignee: Oticon Medical A/S, Smørum (DK)

(21) Appl. No.: 17/965,484

(22) Filed: Oct. 13, 2022

(30) Foreign Application Priority Data
Oct. 14, 2021 (EP) 21202663.7

(51) Int. Cl. H04R 25/00; H04R 9/02

(52) U.S. Cl. CPC H04R 25/606; H04R 9/025; H04R 25/65

(57) ABSTRACT

An electromagnetic vibrator for generating a vibration in order to transmit sound through a bone of a skull of a user to an ear of the user is disclosed. The electromagnetic vibrator comprises at least one moving part comprising a seismic mass; and at least one static part, wherein the at least one static part comprises at least one coil. Additionally a bone anchored hearing device is disclosed.

### FIELD

The present disclosure generally relates to an electromagnetic vibrator for generating a vibration in order to transmit sound through a bone of a skull of a user to an ear of the user. More particularly, the disclosure relates to an electromagnetic vibrator for generating a vibration in order to transmit sound through a bone of a skull of a user to an ear of the user, wherein the electromagnetic vibrator comprises: at least one moving part comprising a seismic mass; and at least one static part comprising at least one coil. Additionally, the present disclosure generally relates to a bone anchored hearing device comprising: the aforementioned electromagnetic vibrator; and an implant for implantation into the bone.

### BACKGROUND

Generally, bone anchored hearing devices are suitable to treat a variety of types of hearing loss and may be suitable for users who cannot derive sufficient benefit from acoustic hearing aids or cochlear implants, or for users who suffer from stuttering problems. Electromagnetic vibrators of bone anchored hearing devices convert a received sound signal into vibrations that are transmitted through a bone of a skull of a user to the cochlea causing generation of nerve impulses, which result in the perception of the received sound. This in turn enables the user to hear.

Known electromagnetic vibrators may, for example, comprise a housing surrounding the vibrating part comprising a magnet and a coil as well as a metal plate on the side of the housing facing the skull as shown in FIG. 1. An implant, such as a titanium screw, is applied into the skull of the patient, and an abutment is applied onto the screw. The housing of the electromagnetic vibrator can be coupled to the abutment.

During vibrational stimulation, the magnet and coil are moving up and down and thus cause the air gap between the magnet and the metal plate to become smaller and larger without collapsing the air gap. For best performance, the air gap between the magnet and the anchor should be small. A small gap, however, can be critical. If the air gap collapses, this results in the magnet being permanently attached to the metal plate. The user then has to go to a professional dispenser for releasing the magnet from the metal plate and re-fitting the vibrator to the user. The electromagnetic vibrator might even get damaged.

On top of that, known electromagnetic vibrators are rather placed hanging in a spring-mass system, which causes corresponding bone anchored hearing devices to be sticking out from the head of a user. Existing electromagnetic vibrators have a poor low frequency response due to the rather high resonance frequency typically in the area between 600 to 900 Hz. The placement of the resonance is a compromise between enough output from the resonance and the ability to provide low frequency amplification. The electromagnetic vibrators further rely on the mass for output such that for a high output, e.g. for a high hearing loss, a high mass is required.

Therefore, there is a need to provide a solution that addresses the above-mentioned problems and in particular allows for simple production and use.

### SUMMARY

According to an aspect, the electromagnetic vibrator for generating a vibration in order to transmit sound through a bone of a skull of a user to an ear of the user may comprise at least one moving part comprising a seismic mass. The electromagnetic vibrator may further comprise at least one static part comprising at least one coil.

According to another aspect, the bone anchored hearing device may comprise the aforementioned electromagnetic vibrator and an implant for implantation into the bone.

Exemplary embodiments of the first and the second aspect may have one or more of the properties described below.

The electromagnetic vibrator allows for a simple construction and use. The seismic mass of the moving part of the electromagnetic vibrator may comprise at least one magnet, wherein the at least one magnet may, for example, comprise a permanent magnet. The moving part, in particular the seismic mass, may also comprise a piezo electric element. The moving part and/or the static part may, however, also comprise further components. The moving part may include only the seismic mass, in particular the magnet, or other components than the coil and the non-magnetic plate.

Providing an air gap between the moving part and the static part of the electromagnetic vibrator is advantageous as it allows for movement of the moving part and thus vibration of the electromagnetic vibrator. It allows for avoiding direct mechanical contact between the moving part and the static part, thereby avoiding mechanical stresses such as friction between these components, which in turn enhances the durability of the electromagnetic vibrator. A great width of the air gap, however, may not be critical. Rather a narrow distance in the gap between the moving part, in particular the seismic mass, and the static part, in particular the coil, allows for high efficiency. In an exemplary embodiment, the air gap has a width of 10 µm to 100 µm, preferably 20 µm to 80 µm, more preferably 20 µm to 60 µm. Tilting and/or wobbling of the electromagnetic vibrator may be controlled.

If the moving part, in particular the seismic mass, touches the static part, i.e. the air gap is closed, the seismic mass will not be stocked to the static part as would be the case in known solutions.

During vibrational stimulation, e.g. when a current is applied to the coil of the static part, the moving part may be moving up and down, i.e. causing the air gap between the moving part and the static part to become smaller and larger without collapsing the air gap. For example, if a positive current is applied, the seismic mass, in particular the magnet, moves downwards, and when a negative current is applied, the seismic mass, in particular the magnet, moves upwards. This allows for a symmetrical force, i.e. the forces generated by the upward and/or downward movement are symmetrical. Thus, low distortion is obtained because the applied forces are linear, i.e. symmetrical force upwards and downwards. Accordingly, the electric current to force relation may be linear and thereby the electromagnetic vibrator has low distortion.

Mass attached to the skull of the user mainly comprises the static part, in particular the coil. The static part may comprise a coil holder and/or an attachment to the skull of the user. The static part may, for example, be attached to an abutment for connection with an implant. Apart from the coil, the static part may be made of non-metal, e.g. plastic. This allows for a light and preferably low cost design. In particular, the weight of the mass attached to the skull of the user may be light to provide a good transmission especially at high frequencies.

At the highest relevant frequency, the mass of the bone may be equivalent to a few grams, so extra grams means lower transmission.

In an exemplary embodiment, the seismic mass, in particular the magnet, and the coil may have at least partially a substantially corresponding shape. For example, the coil may at least partially receive at least a part of the seismic mass, e.g. when the seismic mass moves towards the coil. The moving part may be at least partially arranged around the coil. By arranging the moving part around the coil and/or at least partially corresponding shapes of the seismic mass and the coil, a particular compact architecture of the electromagnetic vibrator is achieved.

In an exemplary embodiment, the seismic mass and/or coil induce vibrations, in particular periodically, by means of magnetic pull and/or magnetic repulsion. Inducing vibrations by means of magnetic pull and/or magnetic repulsion is advantageous in terms of controllability.

The implant for implantation into the bone may be a screw, in particular a titanium screw. The implant may be applied into the skull of the user, the implant in particular being at least partly applied into the bone of the skull of the user. The implant, in particular a small but robust implant such as a screw, may be advantageous in terms of user experience as in the case that e.g. a user does not have to carry the hearing device and thus cannot forget the hearing device. The coupling of the electromagnetic vibrator to the implant may be realized by an abutment, which is applied onto the implant.

In another exemplary embodiment, the vibrator is held against the skin via a magnetic coupling. A magnetic material and/or magnets may be implanted into the user’s skull to complete the magnetic circuit, thereby coupling the vibrator to the user.

The at least one static part may be configured to be fixed to the skull of the user. In regular use, e.g. as a part of a bone anchored hearing device, the electromagnetic vibrator, in particular the static part, is fixed to the skull of the user. For example, an implant, such as a titanium screw, may be applied to the skull of the user, and an abutment is applied onto the screw. The electromagnetic vibrator may be applied to the skull via the abutment. In particular, the static part of the electromagnetic vibrator may be coupled with the abutment.

While the moving part of the electromagnetic vibrator, in particular the magnet, moves in case of an applied current, the static part comprising the coil remains fixed, i.e. does not move due to an applied current.

The at least one static part may further comprise: at least one non-magnetic plate. While in prior art electromagnetic vibrators the air gap between the moving part and a magnetic plate might collapse and result in the magnet being permanently attached to the metal plate, the non-magnetic plate even allows for a contact between the moving part, e.g. the seismic mass, and the non-magnetic plate, i.e. a closed air gap, but the moving part would still not be stocked to the non-magnetic plate. The at least one coil may be attached to the non-magnetic plate.

The electromagnetic vibrator may comprise: a housing, in particular to be at least partly arranged behind the ear of the user, wherein the housing at least partly surrounds the at least one moving part and/or the at least one static part of the electromagnetic vibrator. This allows for a simple design and protection of the components of the electromagnetic vibrator surrounded by the housing. In particular, the housing may on the one hand protect sensitive components of the electromagnetic vibrator. On the other hand, the housing may also protect the user from contact with the components of the electromagnetic vibrator, e.g. hair getting caught in components of the electromagnetic vibrator. In an exemplary embodiment, the electromagnetic vibrator may only consist of the housing, the moving part and the static part. A non-metal plate may be preferably arranged on the side of the housing facing the skull of the user.

The electromagnetic vibrator may comprise: at least one coupling means for coupling the electromagnetic vibrator to an abutment for connection with an implant or implantation into the bone of the user and/or to the implant for implantation into the bone of the user. For example, the electromagnetic vibrator may be arranged onto the abutment via an anchor. The coupling means may particularly cause the static part of the electromagnetic vibrator to stay fixed to the skull of the user.

In particular, the static part of the electromagnetic vibrator may comprise the at least one coupling means. In an exemplary embodiment, the electromagnetic vibrator comprises the moving part with at least one seismic mass and the static part with at least one coil for generating vibrations so as to transmit sound through the bone to the ear; a coupling means, e.g. an anchor, for connecting the electromagnetic vibrator to an abutment or implant; and an air gap between the moving part and the coupling means and/or the static part, particularly the coil.

The electromagnetic vibrator may be coupled to the abutment and/or the implant via the housing. In an exemplary embodiment, the coupling means of the electromagnetic vibrator is connected to the housing. In a further exemplary embodiment, the coupling means forms at least part of the housing.

The electromagnetic vibrator may be coupled to the abutment and thus attached to the skull of the user by applying a negative force on the abutment. For example, the electromagnetic vibrator may be coupled, e.g. clicked on the abutment, but will be pulling outwards and thereby pressing the electromagnetic vibrator, in particular the housing of the electromagnetic vibrator, against the skull of the user.

The electromagnetic vibrator may be thus resting on the skin of the skull of the user, which allows for a very low design making electromagnetic vibrator, in particular a bone anchored hearing device comprising the electromagnetic vibrator, more visible attractive. This allows for a low height of the electromagnetic vibrator, in particular down to substantially the height of the abutment.

The more negative force is applied, the more dynamic force, i.e. vibrations, of the electromagnetic vibrator may be applied. It may be particularly possible to apply sound as vibrations in a wide frequency range including low frequencies. This allows for a high output without having to rely on a high electromagnetic vibrator mass.

The electromagnetic vibrator may comprise at least one vibrator engine for converting an electrical signal into vibrations. The vibrator engine may comprise e.g. a variable reluctance vibrator, a traditional electrodynamic coil and/or magnet as used in loudspeakers or a piezoelectric element. A constant negative force on the abutment e.g. helps the vibrator engine in applying the vibratory force.

The electromagnetic vibrator may comprise: at least one spring, wherein the at least one spring is applied between the seismic mass and the housing. In regular use, e.g. as a part of a bone anchored hearing device, the electromagnetic vibrator, in particular the static part, is fixed to a skull of the user, preferably via an abutment. The electromagnetic vibrator comprising the at least one spring may be holding to the abutment with a negative force. The at least one spring may be pressing the electromagnetic vibrator, in particular the housing, against the skin and thereby the skull of the user. The electromagnetic vibrator, in particular the housing, may be therefore creating a pressure on the skin. The pulling on the abutment may be equal and opposite to the pressing of the electromagnetic vibrator, in particular the housing. The pull on the abutment may be a static pull when attached. This allows for applying a higher dynamic force, i.e. vibrations, to the abutment and/or into the skull of the user.

The at least one spring may be arranged along a first axis which is substantially perpendicular to the skin of the user. The housing may be touching the skin of the user. The spring may be applying a negative force. This allows for pressing the housing towards the skin resulting in a wider frequency range of the sound being applied as vibrations. Furthermore, reliance on a high vibrator mass for high output power can be avoided.

The at least one spring may be arranged along a second axis which is substantially parallel to the skin of the user. This allows for steering the moving part, in particular the seismic mass. Particularly, the at least one spring allows controlling movements of the seismic mass to the sides. The at least one spring may be arranged on at least one side of the seismic mass for the purpose of steering the seismic mass. In an exemplary embodiment, two, three or four springs are applied between the seismic mass and the housing along a second axis, which is about parallel to the skin. It is particularly advantageous to provide an even number of springs, e.g. two, four or six springs, preferably arranged opposite each other. At least two springs may be arranged at equal angular distances, e.g. four springs each with a 90° angle in between.

The electromagnetic vibrator may comprise at least one spring arranged along a first axis which is substantially perpendicular to the skin of the user and at least one spring arranged along a second axis which is substantially parallel to the skin of the user.

The electromagnetic vibrator may comprise: at least one spring force adjustor for adjusting the spring force of the at least one spring. The at least one spring force adjustor allows for adjusting the spring force and thus to customize the pressure on the skin.

The electromagnetic vibrator may comprise: a compliant material for protecting the skin of the user. In an exemplary embodiment, foam is provided for protecting the skin of the user. The compliant material may be e.g. integrated in the housing or provided as protrusions applied to the surface of the housing. The compliant material may be yielding, e.g. if the electromagnetic vibrator is moved relative to the skull of the user. The compliant material may be damping the pressure on the skin of the user, particularly the pressure due to the negative force.

The electromagnetic vibrator may comprise an external part comprising the at least one static part; and an internal part comprising the at least one moving part, wherein the internal part is located between the skin and the bone of the user. The external part may comprise an electromagnet, in particular a coil and a magnet. The internal part may comprise the at least one moving part comprising a seismic mass, wherein the seismic mass preferably comprises at least one magnet.

The internal part may comprise a housing surrounding the seismic mass at least partially and preferably at least one spring between the seismic mass and the housing. In an exemplary embodiment, the internal part may comprise the housing containing the seismic mass, in particular a spring-controlled magnet. Additional seismic mass may be added according to needs. The housing at least partially surrounding the seismic mass may be located between the skin and the bone of the skull of a user. The dynamic force, i.e. the vibrations, may be transferred magnetically, e.g. by having a sound processor containing an electromagnet such as the external part. This allows for the energy being transferred magnetically through the skin and then being converted to mechanical energy to be transferred through the bone. The construction is simple and the energy loss is small which allows for a small power requirement. The seismic mass of the internal part may be magnetic and thus could be part of the force to hold the sound processor in place.

The bone anchored hearing device may comprise an abutment for connection with the implant, wherein the electromagnetic vibrator, preferably the at least one static part of the electromagnetic vibrator, may be fixed to the abutment. In an exemplary embodiment, the abutment comprises a plastic and/or metal and/or is applied onto the implant. Thereby, in an exemplary embodiment, the abutment allows for transferring the vibration from the electromagnetic vibrator, in particular via a coupling means, through the abutment and to the skull of the user. Using a metal is advantageous in terms of vibration properties and robustness of the abutment. Using plastic is advantageous in terms of light weight of the bone anchored hearing device.

The bone anchored hearing device may be or may comprise a hearing aid. The bone anchored hearing device may be or include a hearing aid that is adapted to improve or augment the hearing capability of a user by receiving an acoustic signal from a user’s surroundings, generating a corresponding audio signal, possibly modifying the audio signal and providing the possibly modified audio signal as an audible signal to at least one of the user’s ears. Such audible signals may be provided in the form of an acoustic signal transferred as mechanical vibrations to the user’s inner ears through bone structure of the user’s skull. ‘Improving or augmenting the hearing capability of a user’ may include compensating for an individual user’s specific hearing loss.

The bone anchored hearing device is adapted to be worn in any known way. This may include arranging a unit, in particular parts of or the electromagnetic vibrator, of the bone anchored hearing device attached to a fixture implanted into the skull bone, or arranging a unit, in particular parts of or the electromagnetic vibrator, of the bone anchored hearing device as an entirely or partly implanted unit.

The described bone anchored hearing device may be part of a hearing system. Therein, a “hearing system” refers to a system comprising one or two hearing devices, and a “binaural hearing system” or a bimodal hearing system refers to a system comprising two hearing devices where the devices are adapted to cooperatively provide audible signals to both of the user’s ears either by acoustic stimulation only, acoustic and mechanical stimulation, mechanical stimulation only, acoustic and electrical stimulation, mechanical and electrical stimulation or only electrical stimulation.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a schematic side view of an electromagnetic vibrator according to the prior art;

FIG. 2 shows a schematic side view of a first exemplary embodiment of a bone anchored hearing device according to the second aspect of the present disclosure;

FIG. 3 shows a schematic side view of a second exemplary embodiment of a bone anchored hearing device according to the second aspect of the present disclosure;

FIG. 4 shows a schematic side view of a third exemplary embodiment of a bone anchored hearing device according to the second aspect of the present disclosure;

FIG. 5 shows a schematic side view of a fourth exemplary embodiment of a bone anchored hearing device according to the second aspect of the present disclosure;

FIG. 6 shows a schematic top view of a fifth exemplary embodiment of a bone anchored hearing device according to the second aspect of the present disclosure; and

FIG. 7 shows a schematic side view of a further exemplary embodiment of a bone anchored hearing device according to the second aspect of the present disclosure.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

In FIG. 1, a schematic side view of a prior art electromagnetic vibrator 1 is shown. Such a known electromagnetic vibrator 1 comprises a housing 10 surrounding a seismic mass 3 and a coil 5 as well as a metal plate on the side of the housing 10 facing the skull 100 of the user. An implant 9 is applied into the bone 101 of the skull 100 of the user and an abutment 8 is applied onto the implanted screw. The housing 10 of the electromagnetic vibrator 1 is coupled to the abutment 8 via an anchor.

During vibrational stimulation, the seismic mass 3 and the coil 5 are moving up and down, causing the air gap between the seismic mass 3 and the metal plate to become smaller and larger without collapsing the air gap. If the air gap collapses, this results in the seismic mass 3 being permanently attached to the metal plate. The user then has to go to a professional dispenser for releasing the seismic mass 3 from the metal plate and re-fitting the electromagnetic vibrator 1 to the user. The electromagnetic vibrator might even be damaged.

Therefore, there is a need to provide a solution that addresses the above-mentioned problems and in particular allows for simple production and use.

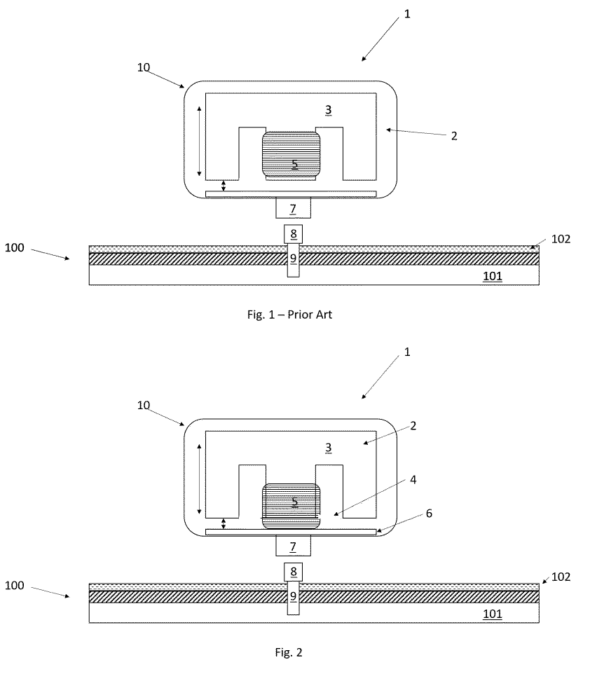

FIG. 2 illustrates a bone anchored hearing device 14 comprising an electromagnetic vibrator 1. The bone anchored hearing device 14 (or hearing instrument, hearing assistance device) may be or include a hearing aid that is adapted to improve or augment the hearing capability of a user by receiving an acoustic signal from a user’s surroundings, generating a corresponding audio signal, possibly modifying the audio signal and providing the possibly modified audio signal as an audible signal to at least one of the user’s ears. ‘Improving or augmenting the hearing capability of a user’ may include compensating for an individual user’s specific hearing loss. Such audible signals may be provided in the form of an acoustic signal transferred as mechanical vibrations to the user’s inner ears through bone structure of the user’s head and/or through parts of the middle ear of the user or electric signals transferred directly or indirectly to the cochlear nerve and/or to the auditory cortex of the user.

Besides the electromagnetic vibrator 1, the bone anchored hearing device 14 may further comprise an implant 9 for implantation into the bone 101 of the skull 100 of a user and/or an abutment 8 for connection with the implant 9.

The electromagnetic vibrator 1 shown in FIG. 2, which may be a part of the bone anchored hearing device 14, comprises a static part 4 with a non-magnetic plate 6 and a coil 5, which may be attached to the non-magnetic plate 6. The static part 4 may also comprise further components other than the coil 5 and the non-magnetic plate 6. The electromagnetic vibrator 1 further comprises a moving part 2, which comprises the seismic mass 3, e.g. a magnet.

The seismic mass 3, in particular the magnet, and the coil 5 may have at least partially a substantially corresponding shape. The coil 5 may at least partially receive at least a part of the seismic mass 3, e.g. when the seismic mass 3 moves towards the coil. The moving part 4 may e.g. be at least partially arranged around the coil 5.

An air gap is provided between the moving part 2 and the static part 4 of the electromagnetic vibrator 1. In an exemplary embodiment, the air gap has a width of 10 µm to 100 µm, preferably 20 µm to 80 µm, more preferably 20 µm to 60 µm. Tilting and/or wobbling of the electromagnetic vibrator may be controlled.

As shown by the large arrow one the left side, the moving part 2 moves up and down in case a current is applied to the coil 5. For example, if a positive current is applied, the moving part 2 moves downwards, and when a negative current is applied, the moving part 2 moves upwards. This allows for a symmetrical force, i.e. the forces generated by the upward and/or downward movement are symmetrical.

The static part 4 may be configured to be fixed to the skull 100 of the user. In regular use, e.g. as a part of the bone anchored hearing device 14, the electromagnetic vibrator 1, in particular the static part 4, is fixed to the skull 100 of the user. While the moving part 2 of the electromagnetic vibrator 1 moves in case of an applied current, the static part 4 comprising the coil 5 remains fixed, i.e. does not move due to an applied current.

The electromagnetic vibrator 1, preferably the at least one static part 4 of the electromagnetic vibrator 1, may be fixed to the abutment 8. For example, the electromagnetic vibrator 1 comprises a coupling means 7, e.g. an anchor, via which the electronic vibrator 1 may be coupled, in particular fixed, to the abutment 8 and/or the implant 9.

The electromagnetic vibrator 1 may comprise the moving part 2 with at least one seismic mass 3 and the static part 2 with at least one coil 5 for generating vibrations so as to transmit sound through the bone to the ear; a coupling means 7, e.g. an anchor, for connecting the electromagnetic vibrator 1 to an abutment 8 and/or implant 9; and an air gap between the moving part 2 and the coupling means 7 and/or the static part 2, particularly the coil 5.

The coupling means 7 may be part of or attached to the housing 10. Preferably, the housing 10 surrounds at least partially the moving part 2 and/or at least partially the static part 4 of the electromagnetic vibrator 1.

The mass attached to the skull 100 of the user mainly comprises the static part 4, in particular the coil 5. The static part 4 may comprise a coil holder and/or an attachment to the skull 100 of the user. The static part 4 may, for example, be attached to an abutment 8 for connection with an implant 9. Apart from the coil 5, the static part 4 may be made of nonmetal, e.g. plastic.

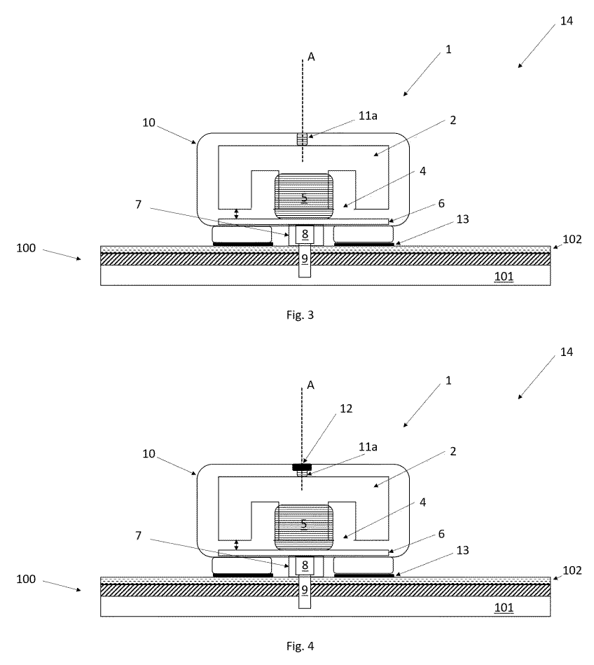

FIG. 3 shows a schematic side view of a second exemplary embodiment of a bone anchored hearing device 14 comprising an electromagnetic vibrator 1. The electromagnetic vibrator 1 is coupled, in particular fixed to the abutment 8 of the bone anchored hearing device 14. A spring 11a is applied between the seismic mass 3 and the housing 10 of the electromagnetic vibrator 1. The spring 11a is arranged along a first axis A which is about perpendicular to the skin 102 of the skull 100 of the user. The housing 10 is touching the skin 102 and the spring 11a is applying a negative force which presses the housing 10 towards the skin 102 resulting in a wider frequency range of the sound being applied as vibrations. The electromagnetic vibrator 1 further comprises a compliant material 13 for protecting the skin 102 of the user. In an exemplary embodiment, foam is provided for protecting the skin 102 of the user. The compliant material may be e.g. integrated in the housing 10 or provided as protrusions.

In regular use, e.g. as a part of a bone anchored hearing device 14, the electromagnetic vibrator 1, in particular the static part 4, is fixed to the skull 100 of a user, preferably via the abutment 8.

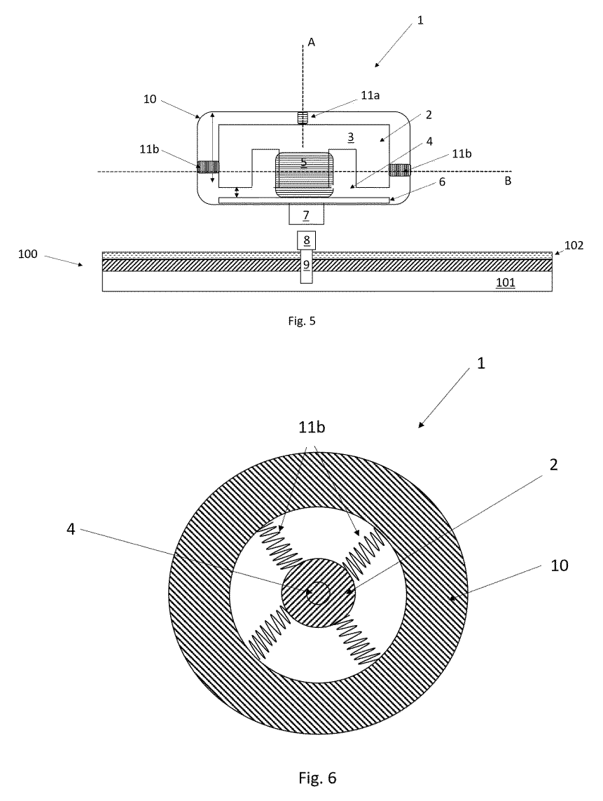

In FIG. 4, the electromagnetic vibrator 1 comprises a spring force adjustor 12 for adjusting the spring force so that it is possible to customize the pressure on the skin 102 of the user. The housing 10 is pressing against the skull 100, preferably through a compliant material 13 like foam.

The electromagnetic vibrator 1 of FIG. 5 comprises at least two springs 11b that are arranged on the side of the seismic mass 3 for the purpose of steering the seismic mass 3. The springs 1 1b are arranged between the seismic mass 3 and the housing 10 along a second axis B, which is about parallel to the skin 102. The electromagnetic vibrator 1 of FIG. 5 further comprises a spring 11a, which is arranged between the housing 10 and the seismic mass 3 along the first axis A of the electromagnetic vibrator 1. It is particularly advantageous to provide an even number of springs 11b, e.g. two, four or six springs 11b, preferably arranged opposite each other. At least two springs 11b may be arranged at equal angular distances, e.g. four springs each with a 90° angle in between.

FIG. 6 illustrates a further exemplary embodiment of a bone anchored hearing device 14. The moving part 2 and the housing 10 of the electromagnetic vibrator 1 may be connected through at least one spring 11b that supports an inward/outward pull. Here, the electromagnetic vibrator 1 comprises four springs 11b, preferably with a 90° angle in between. The springs 11b support a constant pressure on the housing 10 whilst pulling outwards in the abutment 8. Inward and outward forces are equal and opposite. In an exemplary embodiment, a negative force is applied on the abutment 8.

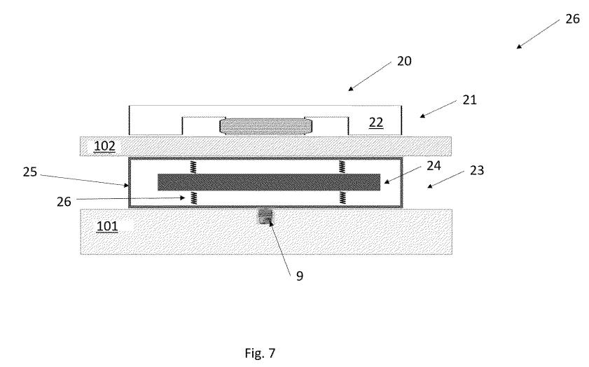

FIG. 7 illustrates a bone anchored hearing device 26 with an electromagnetic vibrator 20 comprising an external part 21 comprising at least one static part 22 and an internal part 23 comprising at least one moving part 24, wherein the internal part 23 is located between the skin 102 and the bone 101 of the user. The external part 21 of the electromagnetic vibrator 20 comprises at least one static part 22, e.g. an electromagnet, in particular a coil and a magnet. The internal part 23 may comprise the at least one moving part 24, preferably comprising a seismic mass, wherein the seismic mass preferably comprises at least one magnet.

The internal part 23 may further comprise a housing 25 and preferably at least one spring 26 between the at least one moving part 24, e.g. the seismic mass, and the housing 25. In an exemplary embodiment, the internal part 23 may comprise the housing 25 containing the moving part 24, in particular a spring-controlled magnet. Additional seismic mass may be added according to needs. The housing 25 surrounding the seismic mass may be located between the skin 102 and the bone 101 of the skull 100 of a user. The dynamic force, i.e. the vibrations, is transferred magnetically by having a sound processor containing an electromagnet such as the external part 21.

The bone anchored hearing device 14, 26 may be part of a hearing system, wherein a “hearing system” refers to a system comprising one or two hearing devices, and a “binaural hearing system” or a bimodal hearing system refers to a system comprising two hearing devices where the devices are adapted to cooperatively provide audible signals to both of the user’s ears.

The hearing system, the binaural hearing system or the bimodal hearing system may further include one or more auxiliary device(s) that communicates with at least one hearing device, the auxiliary device affecting the operation of the hearing devices and/or benefitting from the functioning of the hearing devices. A wired or wireless communication link between the at least one hearing device and the auxiliary device is established that allows for exchanging information (e.g. control and status signals, possibly audio signals) between the at least one hearing device and the auxiliary device. Such auxiliary devices may include at least one of a remote control, a remote microphone, an audio gateway device, a wireless communication device, e.g. a mobile phone (such as a smartphone) or a tablet or another device, e.g. comprising a graphical interface, a public-address system, a car audio system or a music player, or a combination thereof. The audio gateway may be adapted to receive a multitude of audio signals such as from an entertainment device like a TV or a music player, a telephone apparatus like a mobile telephone or a computer, e.g. a PC. The auxiliary device may further be adapted to (e.g. allow a user to) select and/or combine an appropriate one of the received audio signals (or combination of signals) for transmission to the at least one hearing device. The remote control is adapted to control functionality and/or operation of the at least one hearing device. The function of the remote control may be implemented in a smartphone or other (e.g. portable) electronic device, the smartphone / electronic device possibly running an application (APP) that controls functionality of the at least one hearing device.

In general, a hearing device includes i) an input unit such as a microphone for receiving an acoustic signal from a user’s surroundings and providing a corresponding input audio signal, and/or ii) a receiving unit for electronically receiving an input audio signal. The hearing device further includes a signal processing unit for processing the input audio signal and an output unit for providing an audible signal to the user in dependence on the processed audio signal.

The input unit may include multiple input microphones, e.g. for providing direction-dependent audio signal processing. Such directional microphone system is adapted to (relatively) enhance a target acoustic source among a multitude of acoustic sources in the user’s environment and/or to attenuate other sources (e.g. noise). In one aspect, the directional system is adapted to detect (such as adaptively detect) from which direction a particular part of the microphone signal originates. This may be achieved by using conventionally known methods. The signal processing unit may include an amplifier that is adapted to apply a frequency dependent gain to the input audio signal. The signal processing unit may further be adapted to provide other relevant functionality such as compression, noise reduction, etc. The output unit may include an output transducer such as a loudspeaker/ receiver for providing an air-borne acoustic signal to the ear of the user, a mechanical stimulation applied transcutaneously or percutaneously to the skull bone, an electrical stimulation applied to auditory nerve fibers of a cochlea of the user. In some hearing devices, the output unit may include one or more output electrodes for providing the electrical stimulations such as in a Cochlear implant, or the output unit may include one or more vibrators for providing the mechanical stimulation to the skull bone.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

1. An electromagnetic vibrator for generating a vibration in order to transmit sound through a bone of a skull of a user to an ear of the user, comprising:
at least one moving part comprising a seismic mass; and
at least one static part (4, 22), wherein the at least one static part comprises at least one coil.

2. The electromagnetic vibrator according to claim 1, wherein the at least one static part is configured to be fixed to the skull (100) of the user.

3. The electromagnetic vibrator according to claim 1, wherein the at least one static part further comprises:
at least one non-magnetic plate
wherein preferably the at least one coil is fixed to the non-magnetic plate.

4. The electromagnetic vibrator according to claim 1, wherein the electromagnetic vibrator further comprises:
a housing, in particular to be at least partly arranged behind the ear of the user,
wherein the housing at least partly surrounds the at least one moving part and/or the at least one static part of the electromagnetic vibrator.

5. The electromagnetic vibrator according to claim 1, wherein the electromagnetic vibrator further comprises:
at least one coupling means for coupling the electromagnetic vibrator to an abutment for connection with an implant for implantation into the bone (101) of the user and/or to the implant for implantation into the bone of the user.

6. The electromagnetic vibrator according to claim 4, wherein the electromagnetic vibrator is coupled to the abutment and/or the implant via the housing.

7. The electromagnetic vibrator according to claim 4, wherein the electromagnetic vibrator further comprises:
at least one spring,
wherein the at least one spring is applied between the seismic mass and the housing.

8. The electromagnetic vibrator according to claim 7, wherein the at least one spring, is arranged along a first axis which is substantially perpendicular to the skin of the user.

9. The electromagnetic vibrator according to claim 7 wherein the at least one spring, is arranged along a second axis which is substantially parallel to the skin of the user.

10. The electromagnetic vibrator according to claim 7, wherein the electromagnetic vibrator further comprises:
at least one spring force adjustor for adjusting the spring force of the at least one spring.

11. The electromagnetic vibrator according to claim 1, wherein the electromagnetic vibrator further comprises:
a compliant material for protecting the skin of the user.

12. The electromagnetic vibrator according to claim 1, wherein the electromagnetic vibrator further comprises:
an external part comprising the at least one static part; and
an internal part comprising the at least one moving part, wherein the internal part is located between the skin and the bone of the user.

13. The electromagnetic vibrator according to claim 12, wherein the internal part further comprises a housing and preferably at least one spring between the seismic mass and the housing.

14. A bone anchored hearing device comprising:
an electromagnetic vibrator according to claim 1; and
an implant for implantation into the bone.

15. A bone anchored hearing device according to claim 14, wherein the bone anchored hearing device further comprises:
an abutment for connection with the implant;
wherein the electromagnetic vibrator, preferably the at least one static part of the electromagnetic vibrator, is fixed to the abutment.

16. A bone anchored hearing device according to claim 14, wherein the bone anchored hearing device is or comprises a hearing aid.

17. The electromagnetic vibrator according to claim 2, wherein the at least one static part further comprises:
at least one non-magnetic plate,
wherein preferably the at least one coil is fixed to the non-magnetic plate.

18. The electromagnetic vibrator according to claim 2, wherein the electromagnetic vibrator further comprises:
a housing, in particular to be at least partly arranged behind the ear of the user, wherein the housing at least partly surrounds the at least one moving part and/or the at least one static part of the electromagnetic vibrator.

19. The electromagnetic vibrator according to claim 3, wherein the electromagnetic vibrator further comprises:
a housing, in particular to be at least partly arranged behind the ear of the user, wherein the housing at least partly surrounds the at least one moving part and/or the at least one static part of the electromagnetic vibrator.

20. The electromagnetic vibrator according to claim 2, wherein the electromagnetic vibrator further comprises:
at least one coupling means for coupling the electromagnetic vibrator to an abutment for connection with an implant for implantation into the bone of the user and/or to the implant for implantation into the bone of the user.
